(19) United States
(12) Patent Application Publication
(10) Pub. No.: US 2010/0248061 A1
(43) Pub. Date: Sep. 30, 2010

(54) FUEL CELL SYSTEM

(75) Inventor: Norimasa Ishikawa, Asahikawa-shi (JP)

Correspondence Address: KENYON & KENYON LLP, 1500 K STREET N.W., SUITE 700, WASHINGTON, DC, 20005, US

(73) Assignee: Toyota Jidosha Kabushiki Kaisha, Toyota-shi (JP)

(21) Appl. No.: 12/742,583

(22) PCT Filed: Oct. 29, 2008
(86) PCT No.: PCT/JP2008/069597

§ 371 Date: May 12, 2010

(30) Foreign Application Priority Data
Nov. 16, 2007 (JP) 2007-297886

(51) Int. Cl. H01M 8/04

(52) U.S. Cl. 429/443

(57) ABSTRACT

A fuel cell system having an on-off valve disposed in a fuel supply flow path implements highly accurate control of the on-off valve by properly correcting a detected pressure value of a fuel gas on an upstream side of the on-off valve. The fuel cell system includes a fuel cell, a fuel supply flow path for supplying a fuel gas to be supplied from a fuel supply source to the fuel cell, an on-off valve which adjusts the state of a gas on an upstream side of the fuel supply flow path and supplies the gas to a downstream side, a pressure sensor which detects the pressure value of the fuel gas on the upstream side of the on-off valve of the fuel supply flow path, and a control means which controls the on-off valve on the basis of the pressure value detected by the pressure sensor. The fuel cell system further includes a pressure correcting means which corrects a pressure value detected by the pressure sensor on the basis of a fuel consumption amount of the fuel cell and a drive cycle of the on-off valve.

### TECHNICAL FIELD

The present invention relates to a fuel cell system.

Hitherto, there has been proposed and put to practical use a fuel cell system provided with a fuel cell which receives supplied reactant gases (a fuel gas and an oxidizing gas) and generates electric power. Currently, there has been proposed a technique for regulating the pressure of the fuel gas in a fuel supply flow path by disposing an electromagnetic on-off valve, such as an injector, in the fuel supply flow path of the fuel cell system and controlling the operating status of the on-off valve.

In a conventional fuel cell system provided with such an injector, the pressure value of the fuel gas on the upstream side of the injector in the fuel supply flow path is detected by using a pressure sensor, and the injection flow rate of the injector is controlled by using the detected pressure value (refer to, for example, patent document 1).

Patent document 1: Japanese Patent Application Laid-Open No. 2007-165163

### DISCLOSURE OF THE INVENTION

### Problem to be Solved by the Invention

The pressure of the fuel gas on the upstream side of the injector in the fuel supply flow path changes according to various physical amounts (the amount of electric power generated in a fuel cell, the drive cycle of an injector, and the like) related to the operational state of a fuel cell system. For this reason, simply using the detected pressure value of the fuel gas on the upstream side of the injector, as with the art disclosed in patent document 1 described above, may make it difficult to control the injection flow rate of the injector with high accuracy.

The present invention has been made in view of the aforesaid circumstances, and it is an object of the invention to fulfill highly accurate control of an on-off valve by properly correcting a detected pressure value of a fuel gas on the upstream side of an on-off valve in a fuel cell system having an on-off valve, such as an injector, disposed in a fuel supply flow path.

### Means for Solving the Problem

To fulfill the aforesaid object, a fuel cell system in accordance with the present invention includes: a fuel cell; a fuel supply flow path for supplying a fuel gas supplied from a fuel supply source to the fuel cell; an on-off valve which regulates the state of a gas on an upstream side of the fuel supply flow path and supplies the gas to a downstream side; a pressure sensor which detects the pressure value of the fuel gas on the upstream side of the on-off valve of the fuel supply flow path; control means which controls the on-off valve on the basis of the pressure value detected by the pressure sensor; and pressure correcting means which corrects the pressure value detected by the pressure sensor on the basis of at least one of a power generation amount in the fuel cell, a fuel consumption amount in the fuel cell, a drive cycle of the on-off valve, and open valve command time of the on-off valve.

Using the aforesaid arrangement makes it possible to correct a pressure value (a detected pressure value) of a fuel gas on the upstream side of the on-off valve detected by the pressure sensor on the basis of various physical amounts (the fuel consumption amount in a fuel cell, the drive cycle of the on-off valve, and the like) related to the operational state of the system. Hence, even if the operational state (e.g., the drive cycle) of the system changes, the on-off valve can be controlled with high accuracy by using a detected pressure value that has been corrected. A term “gas state” means the state of a gas indicated in terms of a flow rate, a pressure, a temperature, a molecular concentration and the like and includes, in particular, at least one of a gas flow rate and a gas pressure.

The aforesaid fuel cell system has a correction map for calculating a corrective pressure decrease on the basis of at least one of the power generation amount in the fuel cell, the fuel consumption amount in the fuel cell, the drive cycle of the on-off valve, and the open valve command time of the on-off valve, and may adopt a pressure correcting means which corrects a detected pressure value on the basis of a pressure value detected by the pressure sensor and a corrective pressure decrease calculated by using the correction map.

Further, the fuel cell system may adopt an upstream pressure detecting means (e.g., a tank pressure sensor which detects the pressure of a hydrogen gas in a hydrogen tank serving as a fuel supply source) which detects the pressure value of the fuel gas on the upstream side from the pressure sensor, and a pressure correcting means which corrects the pressure value detected by the pressure sensor on the basis of a pressure value detected by the upstream pressure detecting means.

Further, the fuel cell system may adopt an injector as the on-off valve.

The injector is an electromagnetically driven on-off valve capable of regulating the gas state (a gas flow rate and a gas pressure) by directly driving a valve element thereby to move the valve element away from a valve seat with an electromagnetic drive power at a predetermined drive cycle. A predetermined controller drives the valve element of the injector so as to control an injection timing and injection time of a fuel gas, thus permitting highly accurate control of the flow rate and the pressure of a fuel gas.

### EFFECT OF THE INVENTION

According to the present invention, in a fuel cell system having an on-off valve, such as an injector, disposed in a fuel supply flow path, highly accurate control of the on-off valve can be fulfilled by properly correcting a detected pressure value of a fuel gas on an upstream side of the on-off valve.

### BEST MODE FOR CARRYING OUT THE INVENTION

Referring to the accompanying drawings, a fuel cell system 1 according to an embodiment of the present invention will now be described. In the present embodiment, an example in which the present invention is applied to an in-vehicle power generating system of a fuel cell hybrid vehicle will be described.

First, using FIGS. 1 to 4, the configuration of the fuel cell system 1 according to the embodiment of the present invention will be described.

As illustrated in FIG. 1, the fuel cell system 1 according to the present embodiment is provided primarily with a fuel cell 10 which receives supplied reactant gases (an oxidizing gas and a fuel gas) and generates electric power, an oxidizing gas piping system 2 which supplies air serving as the oxidizing gas to the fuel cell 10, a hydrogen gas piping system 3 which supplies a hydrogen gas as the fuel gas to the fuel cell 10, and a controller 4 which integrally controls the entire system.

The fuel cell 10 has a stack structure wherein a predetermined number of single cells which generate electric power by receiving supplied reactant gases is stacked. The electric power generated by the fuel cell 10 is supplied to a PCU (Power Control Unit) 11. The PCU 11 is provided with an inverter, a DC-DC converter and the like disposed between the fuel cell 10 and a traction motor 12. Further, a current sensor 13, which detects current during power generation, is attached to the fuel cell 10.

The oxidizing gas piping system 2 has an air supply flow path 21 for supplying an oxidizing gas (air) humidified by a humidifier 20 to the fuel cell 10, an air exhaust flow path 22 which guides an oxidizing off-gas discharged from the fuel cell 10 to the humidifier 20, and an exhaust flow path 23 for guiding the oxidizing off-gas from the humidifier 20 to the outside. The air supply flow path 21 is provided with a compressor 24 which takes in the oxidizing gas from the atmosphere and pressure-feeds the introduced oxidizing gas to the humidifier 20.

The hydrogen gas piping system 3 has a hydrogen tank 30 serving as a fuel supply source storing a hydrogen gas of a high pressure (e.g., 70 MPa), a hydrogen supply flow path 31 serving as a fuel supply flow path for supplying the hydrogen gas of the hydrogen tank 30 to the fuel cell 10, and a circulation flow path 32 for returning hydrogen off-gas exhausted from the fuel cell 10 back to the hydrogen supply flow path 31. The present embodiment is provided with a tank pressure sensor (not shown), which detects the pressure of the hydrogen gas in the hydrogen tank 30. The information regarding the pressure of the hydrogen gas in the hydrogen tank 30 detected by the tank pressure sensor is transmitted to the controller 4 and used for correcting a primary pressure, which will be discussed hereinafter. The tank pressure sensor corresponds to an embodiment of an upstream pressure detecting means in the present invention.

In place of the hydrogen tank 30, a reformer which generates a hydrogen-rich reformed gas from a hydrocarbon-based fuel and a high-pressure gas tank which stores, under a high pressure, the reformed gas produced by the reformer may be adopted as the fuel supply source. Alternatively, a tank having a hydrogen occluded alloy may be adopted as the fuel supply source.

The hydrogen supply flow path 31 is provided with a shutoff valve 33 which cuts off or enables the supply of the hydrogen gas from the hydrogen tank 30, a regulator 34 which regulates the pressure of the hydrogen gas, and an injector 35. Further, a primary side pressure sensor 41 and a temperature sensor 42 for detecting a pressure value and a temperature value of the hydrogen gas in the hydrogen supply flow path 31 are provided on the upstream side of the injector 35. Further, a secondary side pressure sensor 43 for detecting the pressure value of the hydrogen gas in the hydrogen supply flow path 31 is provided between the downstream side of the injector 35 and the upstream side of a merging portion of the hydrogen supply flow path 31 and the circulation flow path 32.

The regulator 34 is a device which regulates the pressure on the upstream side thereof (a primary side pressure) to a preset secondary pressure. In the present embodiment, a mechanical pressure reducing valve for reducing the primary side pressure is adopted as the regulator 34. As the construction of the mechanical pressure reducing valve, a publicly known construction may be used. The publicly known construction includes an enclosure formed of a backpressure chamber and a pressure-regulating chamber, which are separated by a diaphragm, the primary side pressure being reduced to a predetermined pressure in the pressure-regulating chamber by a backpressure of the backpressure chamber so as to obtain the secondary pressure. In the present embodiment, as illustrated in FIG. 1, two regulators 34 are disposed on the upstream side of the injector 35, thereby making it possible to effectively reduce the pressure on the upstream side of the injector 35. This arrangement permits a higher degree of design freedom of the mechanical structure (the valve element, the enclosure, flow paths, the drive devices, and the like) of the injector 35. Moreover, the pressure on the upstream side of the injector 35 can be reduced, thus making it possible to restrain the difficulty of movement of the valve element of the injector 35 caused by an increase in the pressure difference between the upstream pressure and the downstream pressure of the injector 35. Hence, the variable pressure regulating width of the pressure on the downstream side of the injector 35 can be increased and the deterioration of the responsiveness of the injector 35 can be restrained.

The injector 35 is an electromagnetically driven on-off valve capable of adjusting a gas flow rate and a gas pressure by directly driving the valve element to move the valve element away from a valve seat with an electromagnetic drive force at a predetermined drive cycle. The injector 35 is provided with a valve seat having an injection hole through which a gas fuel, such as a hydrogen gas, is injected, a nozzle body which supplies and guides the gas fuel to the injection hole, and the valve element which is accommodated and retained in the nozzle body and configured to move in the axial direction (in the direction in which the gas flows) with respective to the nozzle body and which opens and closes the injection hole. The valve element of the injector 35 is driven by, for example, a solenoid, and the opening area of the injection hole can be changed in two steps or multiple steps by turning on/off a pulsing excitation current supplied to the solenoid. The gas injection time and the gas injection timing of the injector 35 are controlled by control signals output from the controller 4 thereby to control the flow rate and the pressure of the hydrogen gas with high accuracy. The injector 35 is adapted to directly drive the valve (the valve element and the valve seat) by an electromagnetic drive force to open/close the valve. The drive cycle of the injector permits control up to a high-response range, exhibiting high responsiveness.

In the present embodiment, as illustrated in FIG. 1, the injector 35 is disposed on the upstream side from a merging portion A1 of the hydrogen supply flow path 31 and the circulation flow path 32. Further, in the case where a plurality of hydrogen tanks 30 is adopted as the fuel supply source, as indicated by the dashed lines in FIG. 1, the injector 35 is disposed on the downstream side from a portion where the hydrogen gases supplied from the hydrogen tanks 30 merge (a hydrogen gas merging portion A2).

A discharge flow path 38 is connected to the circulation flow path 32 via the gas-liquid separator 36 and an exhaust/drainage valve 37. The gas-liquid separator 36 recovers moisture from the hydrogen off-gas. The exhaust/drainage valve 37 is actuated in response to a command from the controller 4 to discharge (purge) the moisture recovered by the gas-liquid separator 36 and the hydrogen off-gas containing impurities in the circulation flow path 32. The circulation flow path 32 is provided with a hydrogen pump 39 which pressurizes the hydrogen off-gas in the circulation flow path 32 and feeds the pressurized hydrogen off-gas to the hydrogen supply flow path 31. The hydrogen off-gas exhausted via the exhaust/drainage valve 37 and the discharge flow path 38 is diluted by the diluter 40 and merged with the oxidizing off-gas in the exhaust flow path 23.

The controller 4 detects the manipulated variable of an acceleration operating member (an accelerator pedal or the like) provided in a vehicle and controls the operation of various types of devices in the system upon receipt of control information, such as an acceleration request value (e.g., a required amount of electric power to be generated, which is received from a load device, such as the traction motor 12). The load device is a generic term referring to auxiliary devices necessary to operate the fuel cell 10 (e.g., a motor of the compressor 24, a motor of the hydrogen pump 39, and the like), the actuators used with various types of devices (a transmission, a wheel controller, a steering device, a suspension device, and the like) involved in the travel of a vehicle, and power consuming devices, including an air conditioning device (an air conditioner), lighting, and audio equipment, in a driver compartment, in addition to the traction motor 12.

The controller 4 is constituted of a computer system, which is not shown. The computer system is provided primarily with a CPU, a ROM, a RAM, an HDD, an input/output interface, and a display. Various types of control programs recorded in the ROM are read and executed by the CPU, thereby performing various types of control operations.

More specifically, as illustrated in FIG. 2, the controller 4 calculates the amount of the hydrogen gas consumed by the fuel cell 10 (hereinafter referred to as “the hydrogen consumption amount”) on the basis of the operating condition of the fuel cell 10 (the current value at the time of power generation in the fuel cell 10 detected by the current sensor 13) (a function for calculating fuel consumption amount: B1). In the present embodiment, the hydrogen consumption amount is calculated and updated for each arithmetic cycle of the controller 4 by using a specific arithmetic expression indicating a relationship between current values and hydrogen consumption amounts of the fuel cell 10.

Further, the controller 4 calculates a target pressure value of the hydrogen gas at a position on the downstream of the injector 35 (the target pressure of the gas supplied to the fuel cell 10) on the basis of the operating condition of the fuel cell 10 (the current value at the time of power generation in the fuel cell 10 detected by the current sensor 13) (a function for calculating a target pressure value: B2). In the present embodiment, the target pressure value at the position where the secondary side pressure sensor 43 is disposed is calculated and updated for each arithmetic cycle of the controller 4 by using a specific map which represents a relationship between current values and target pressure values of the fuel cell 10.

Further, the controller 4 calculates a feedback correction flow rate on the basis of the difference between the calculated target pressure value and the pressure value (the detected pressure value) at the position on the downstream side of the injector 35, which has been detected by the secondary side pressure sensor 43 (a function for calculating a feedback correction flow rate: B3). The feedback correction flow rate is the hydrogen gas flow rate to be added to a hydrogen consumption amount in order to reduce the difference between a target pressure value and a detected pressure value. In the present embodiment, a PI feedback control law is used to calculate and update the feedback correction flow rate for each arithmetic cycle of the controller 4.

Further, the controller 4 corrects the primary pressure (the pressure value of the hydrogen gas on the upstream side of the injector 35) detected by the primary side pressure sensor 41 on the basis of the calculated hydrogen consumption amount and the tank pressure detected by a tank pressure sensor (the pressure of the hydrogen gas in the hydrogen tank 30) (a function for correcting the primary pressure: B4). In other words, the controller 4 functions as the pressure correcting means in the present invention.

Here, the correction of the primary pressure will be described by using FIG. 3 and FIG. 4. The pressure value of the hydrogen gas on the upstream side of the injector 35 (the primary pressure) changes according to the opening/closing operation of the injector 35 due mainly to a piping pressure loss of the hydrogen supply flow path 31 or low responsiveness of the regulator 34. Specifically, as illustrated in FIG. 3A through FIG. 3C, the valve of the injector 35 actually opens with a slight delay from an open valve command of the injector and the primary pressure starts to decrease at the same time. Further, the primary pressure continues to decrease until the valve of the injector 35 actually closes, then starts to increase at the same time when the valve of the injector 35 closes. After that, the primary pressure repeatedly decreases and increases as the injector 35 is opened and closed and then converges to an approximately constant reference pressure P_{M} after predetermined time elapses. In the present embodiment, an estimated value of the reference pressure P_{M} (a corrected value of the primary pressure) is calculated according to a relational expression given below.

P_{M}=P₁−(½)·ΔP

In the above relational expression, P₁ denotes a detected primary pressure value immediately after the valve of the injector 35 is opened and ΔP denotes a primary pressure decrease (a corrective pressure decrease) until first valve closing of the injector 35 from the instant P₁ is detected, as illustrated in FIG. 3B and FIG. 3C. The value of ΔP changes according to the operational state of the fuel cell system 1. Hence, in the present embodiment, the primary pressure decrease corresponding to a hydrogen consumption amount is calculated by using a correction map (a map indicating a relationship between the hydrogen consumption amount of the fuel cell 10 and the primary pressure decrease) given in FIG. 4. Further, in the present embodiment, the correction map is prepared for each tank pressure (e.g., the correction map for a tank pressure P_{T1} is denoted by M₁, and the correction map for a tank pressure P_{T2} is denoted by M₂) as illustrated in FIG. 4. Thus, the primary pressure decrease corresponding to a hydrogen consumption amount and a tank pressure are calculated according to a correction map.

Further, the controller 4 calculates the static flow rate of the upstream of the injector 35 on the basis of the gas state (the primary pressure correction value and the temperature of the hydrogen gas detected by the temperature sensor 42) of the injector 35 (a function for calculating a static flow rate: B5). In the present embodiment, the static flow rate is calculated and updated for each arithmetic cycle of the controller 4 by using a specific arithmetic expression representing a relationship between the pressure and the temperature of the hydrogen gas on the upstream side of the injector 35 and the static flow rate.

Further, the controller 4 calculates the invalid injection time of the injector 35 on the basis of the gas state (the primary pressure correction value and the temperature) at the upstream of the injector 35 and an applied voltage (a function for calculating invalid injection time: B6). Here, the invalid injection time means the time required for actual injection to begin from the instant the injector 35 receives a control signal from the controller 4. In the present embodiment, the invalid injection time is calculated and updated for each arithmetic cycle of the controller 4 by using a specific map indicating a relationship among the pressures and temperatures of the hydrogen gas on the upstream side of the injector 35, applied voltages, and invalid injection time.

Further, the controller 4 adds the hydrogen consumption amount and the feedback correction flow rate to calculate the injection flow rate of the injector 35 (a function for calculating an injection flow rate: B7). Further, the controller 4 calculates the drive cycle of the injector 35 on the basis of the injection flow rate of the injector 35 and the primary pressure correction value (a function for calculating a drive cycle: B8). Here, the drive cycle means a stepped (ON/OFF) waveform cycle indicating the ON/OFF state of the injection hole of the injector 35. In the present embodiment, the drive cycle is calculated and updated for each arithmetic cycle of the controller 4 by using a specific map indicating a relationship among the injection flow rate of the injector 35, the primary pressure, and the drive cycle. In the present embodiment, as illustrated in FIG. 4, the drive cycle is set such that the drive cycle changes in a range wherein the hydrogen consumption amount is Q₁ or less and the drive cycle remains constant in a range wherein the hydrogen consumption amount exceeds Q₁.

Further, the controller 4 multiplies the value, which is obtained by dividing the injection flow rate of the injector 35 by the static flow rate, by the drive cycle of the injector 35 thereby to calculate the basic injection time of the injector 35, and also calculates the total injection time of the injector 35 by adding the basic injection time and the invalid injection time (a function for calculating the total injection time: B9). Then, the controller 4 outputs a control signal for implementing the total injection time of the injector 35 calculated according to the procedure described above so as to control the gas injection time and the gas injection timing of the injector 35, thereby adjusting the flow rate and the pressure of the hydrogen gas supplied to the fuel cell 10. The controller 4 also functions as a control means in the present invention.

Referring now to the flowchart of FIG. 5, the method for operating the fuel cell system 1 according to the present embodiment will be described.

In a normal operation mode of the fuel cell system 1, the hydrogen gas is supplied from the hydrogen tank 30 to a fuel electrode of the fuel cell 10 via the hydrogen supply flow path 31 and air with humidity thereof having been adjusted is supplied to an oxidizing electrode of the fuel cell 10 via the air supply flow path 21, thereby implementing power generation. At this time, the electric power (required electric power) to be drawn out from the fuel cell 10 is calculated by the controller 4 and the hydrogen gas and air in the amounts corresponding to the calculated amount of electric power to be generated are supplied into the fuel cell 10. In the present embodiment, the pressure of the hydrogen gas supplied to the fuel cell 10 is controlled with high accuracy in the normal operation mode described above.

More specifically, first, the controller 4 of the fuel cell system 1 detects, by using the current sensor 13, the current value when the fuel cell 10 generates electric power (a current detection step: S1). Then, the controller 4 calculates the amount of the hydrogen gas consumed in the fuel cell 10 (the hydrogen consumption amount) on the basis of the current value detected by the current sensor 13 (a fuel consumption amount calculation step: S2).

Subsequently, the controller 4 calculates a target pressure value of the hydrogen gas at a position on the downstream side of the injector 35 on the basis of the current value detected by the current sensor 13, and also detects the pressure value at the position on the downstream side of the injector 35 by using the secondary side pressure sensor 43. The controller 4 then calculates a feedback correction flow rate on the basis of a difference between the calculated target pressure value and the pressure value that has been detected (the detected pressure value) (a feedback correction flow rate calculation step: S3). Subsequently, the controller 4 adds the hydrogen consumption amount calculated in the fuel consumption flow rate calculation step S2 and the feedback correction flow rate calculated in the feedback correction flow rate calculation step S3 to calculate the injection flow rate of the injector 35 (an injection flow rate calculation step: S4).

Subsequently, the controller 4 detects the primary pressure (the pressure value of the hydrogen gas on the upstream side of the injector 35) by using the primary side pressure sensor 41 and corrects the detected primary pressure on the basis of the hydrogen consumption amount calculated in the fuel consumption flow rate calculation step S2 (a primary pressure detection/correction step: S5). Then, the controller 4 calculates the static flow rate of the upstream of the injector 35 on the basis of the primary pressure correction value calculated in the primary pressure detection/correction step S5 and the temperature of the hydrogen gas on the upstream of the injector 35 detected by the temperature sensor 42 (a static flow rate calculation step: S6).

Subsequently, the controller 4 calculates the drive cycle of the injector 35 on the basis of the injection flow rate of the injector 35 calculated in the injection flow rate calculation step S4 and the primary pressure correction value calculated in the primary pressure detection/correction step S5 (a drive cycle calculation step: S7). Then, the controller 4 calculates the basic injection time of the injector 35 by multiplying the value, which is obtained by dividing the injection flow rate of the injector 35 by the static flow rate, by the drive cycle of the injector 35 (a basic injection time calculation step: S8).

Subsequently, the controller 4 calculates the invalid injection time of the injector 35 on the basis of the primary pressure correction value calculated in the primary pressure detection/correction step S5 and the temperature of the hydrogen gas on the upstream of the injector 35 detected by the temperature sensor 42, and an applied voltage (an invalid injection time calculation step: S9). The controller 4 then adds the basic injection time of the injector 35 calculated in the basic injection time calculation step S8 and the invalid injection time calculated in the invalid injection time calculation step S9, thereby calculating the total injection time of the injector 35 (a total injection time calculation step: S10).

Thereafter, the controller 4 outputs a control signal related to the total injection time of the injector 35 calculated in the total injection time calculation step S10 so as to control the gas injection time and the gas injection timing of the injector 35, thus adjusting the flow rate and the pressure of the hydrogen gas supplied to the fuel cell 10.

In the fuel cell system 1 according to the embodiment described above, the primary pressure detected by the primary side pressure sensor 41 (the pressure value of the hydrogen gas on the upstream side of the injector 35) can be corrected on the basis of the physical amounts related to the operational condition of the system (the hydrogen consumption amount in the fuel cell 10 and a tank pressure). Hence, even in the case where the operational condition of the system changes, the injector 35 can be controlled with high accuracy by using a primary pressure that has been corrected.

In the embodiment described above, the example in which the primary pressure has been corrected on the basis of the hydrogen consumption amount and the tank pressure has been presented. Alternatively, however, the primary pressure can be corrected on the basis of other physical amounts related to the operational condition of the system. For instance, as illustrated in FIG. 6, the primary pressure may be corrected on the basis of the drive cycle of the injector 35 and a tank pressure. In this case, a correction map indicating a relationship among drive cycles, tank pressures, and primary pressure decreases is prepared beforehand, a primary pressure decrease corresponding to detected (calculated) drive cycle and tank pressure is calculated by using the correction map, and a primary pressure correction value can be calculated according to the aforesaid relational expression. Alternatively, as illustrated in FIG. 7, the primary pressure can be corrected on the basis of the power generation amount (a power generation current value) of the fuel cell 10 or the primary pressure can be corrected on the basis of an open valve command time of the injector 35.

Further, in the embodiment described above, the example in which the tank pressure sensor for detecting the pressure of the hydrogen gas in the hydrogen tank 30 has been adopted as the upstream pressure detecting means has been presented. Alternatively, however, a pressure sensor may be provided on the upstream side of the regulator 34 of the hydrogen supply flow path 31 (between the regulator 34 and the shutoff valve 33 or between the shutoff valve 33 and the hydrogen tank 30) and the pressure sensor can be operated as an upstream pressure detecting means.

Further, in the aforesaid embodiment, the example wherein the hydrogen gas piping system 3 of the fuel cell system 1 is provided with the circulation flow path 32 has been presented. Alternatively, however, the circulation flow path 32 can be removed by directly connecting the discharge flow path 38 to the fuel cell 10. In the case where such configuration (a dead-end system) is adopted, the same operation and effect as those of the aforesaid embodiment can be obtained by correcting the primary pressure in the same manner as that in the aforesaid embodiment by the controller 4.

Further, in the aforesaid embodiment, the example wherein the circulation flow path 32 is provided with the hydrogen pump 39 has been presented. Alternatively, however, an ejector may be adopted in place of the hydrogen pump 39. Further, in the aforesaid embodiment, the example wherein the hydrogen supply flow path 31 is provided with the shutoff valve 33 and the regulator 34 has been presented. However, the injector 35 functions as a variable regulator and also functions as a shutoff valve for cutting off the supply of the hydrogen gas, so that the shutoff valve 33 and the regulator 34 do not have to be necessarily provided. Thus, adopting the injector 35 makes it possible to omit the shutoff valve 33 and the regulator 34, thereby permitting a reduced size and lower cost of the system.

### INDUSTRIAL APPLICABILITY

As indicated by the aforesaid embodiments, the fuel cell system in accordance with the present invention can be mounted in a fuel cell hybrid vehicle and can be also installed in a variety of mobile bodies (e.g., a robot, a ship, aircraft, and the like) in addition to a fuel cell hybrid vehicle. Moreover, the fuel cell system in accordance with the present invention may also be applied to a fixed power generation system used as power generating equipment for architecture (a house, a building, or the like).

### BRIEF DESCRIPTION OF THE DRAWINGS

FIG. 1 It is a block diagram of a fuel cell system according to an embodiment of the present invention.

FIG. 2 It is a control block diagram for describing a control mode of a controller of the fuel cell system illustrated in FIG. 1.

FIG. 3A It is a timing chart of an open valve command for an injector of the fuel cell system illustrated in FIG. 1.

FIG. 3B It is a timing chart of an actual operation for opening a valve of the injector of the fuel cell system illustrated in FIG. 1.

FIG. 3C It is a timing chart of a detected pressure value on an upstream side of the injector of the fuel cell system illustrated in FIG. 1.

FIG. 4 It is a map illustrating a relationship between a hydrogen consumption amount and a primary pressure decrease in a fuel cell of the fuel cell system illustrated in FIG. 1.

FIG. 5 It is a flowchart for describing the method for operating the fuel cell system illustrated in FIG. 1.

FIG. 6 It is a control block diagram for describing another control mode of the controller of the fuel cell system illustrated in FIG. 1.

FIG. 7 It is a control block diagram for describing yet another control mode of the controller of the fuel cell system illustrated in FIG. 1.

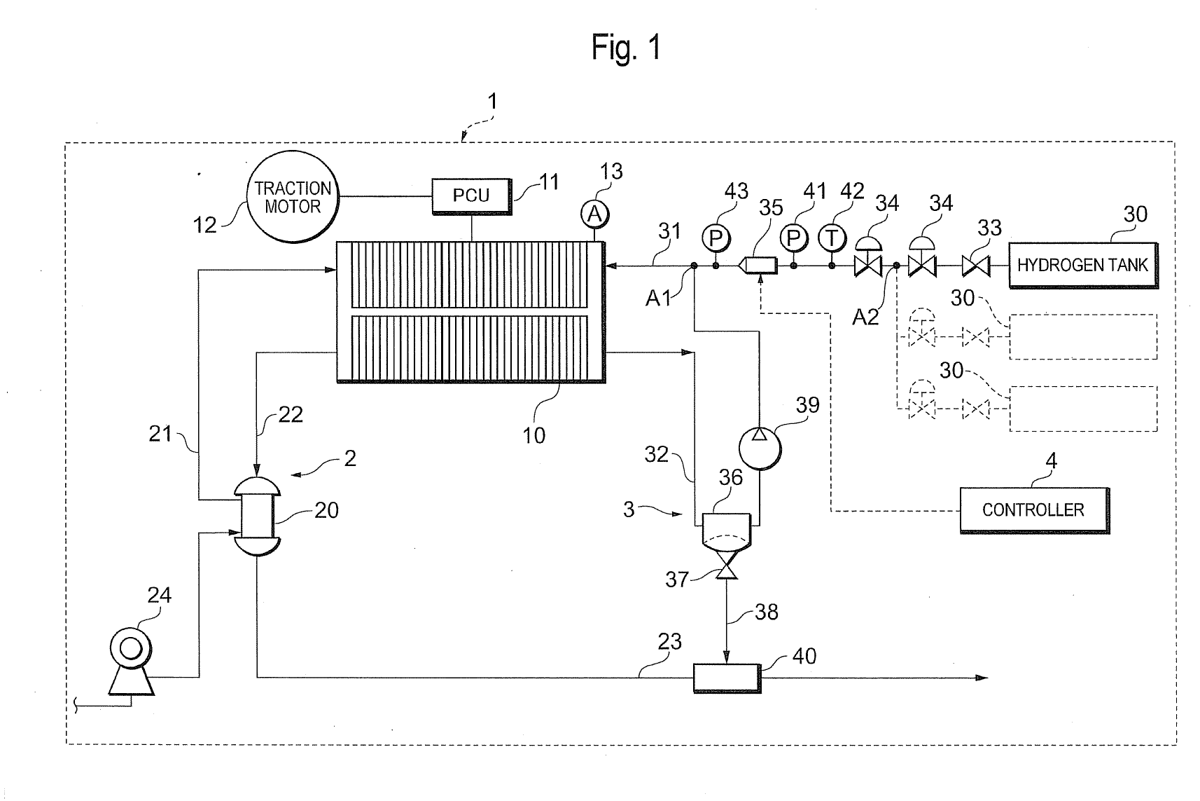

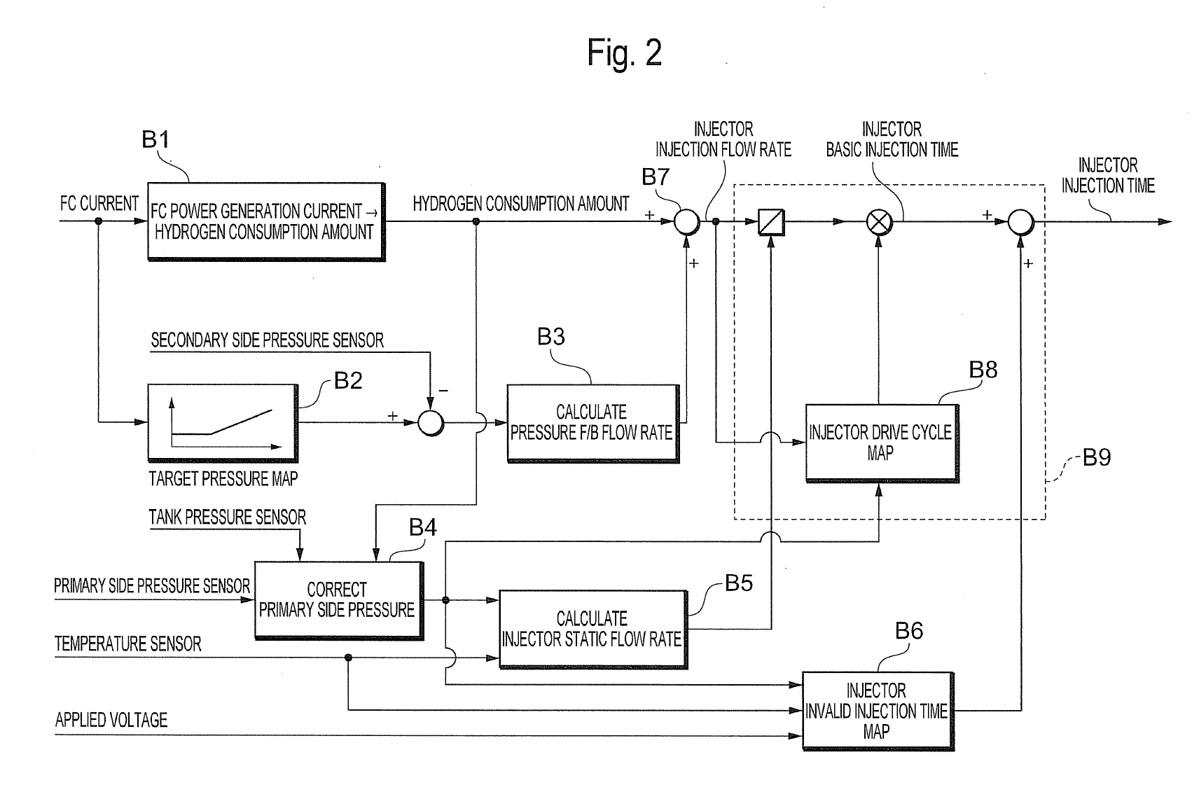

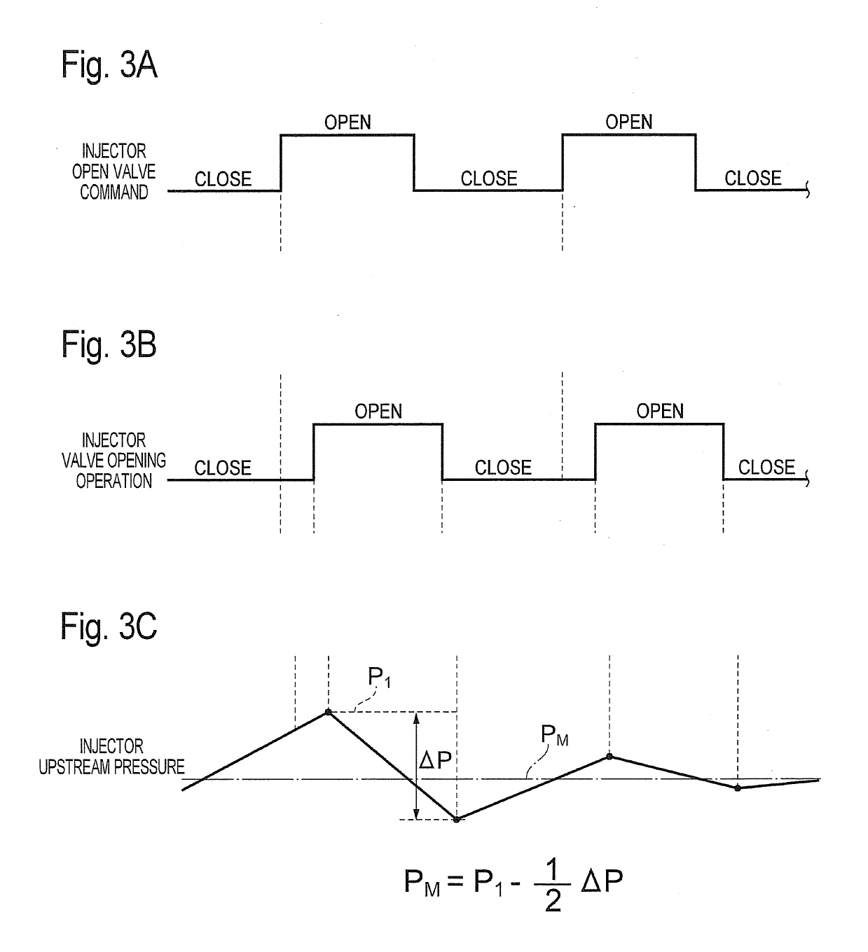

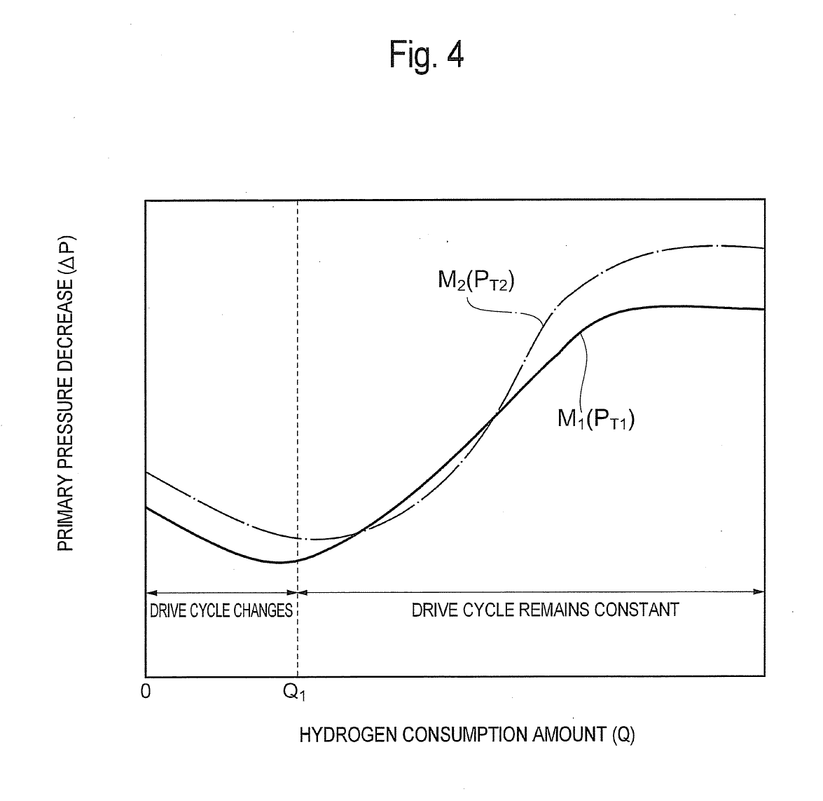

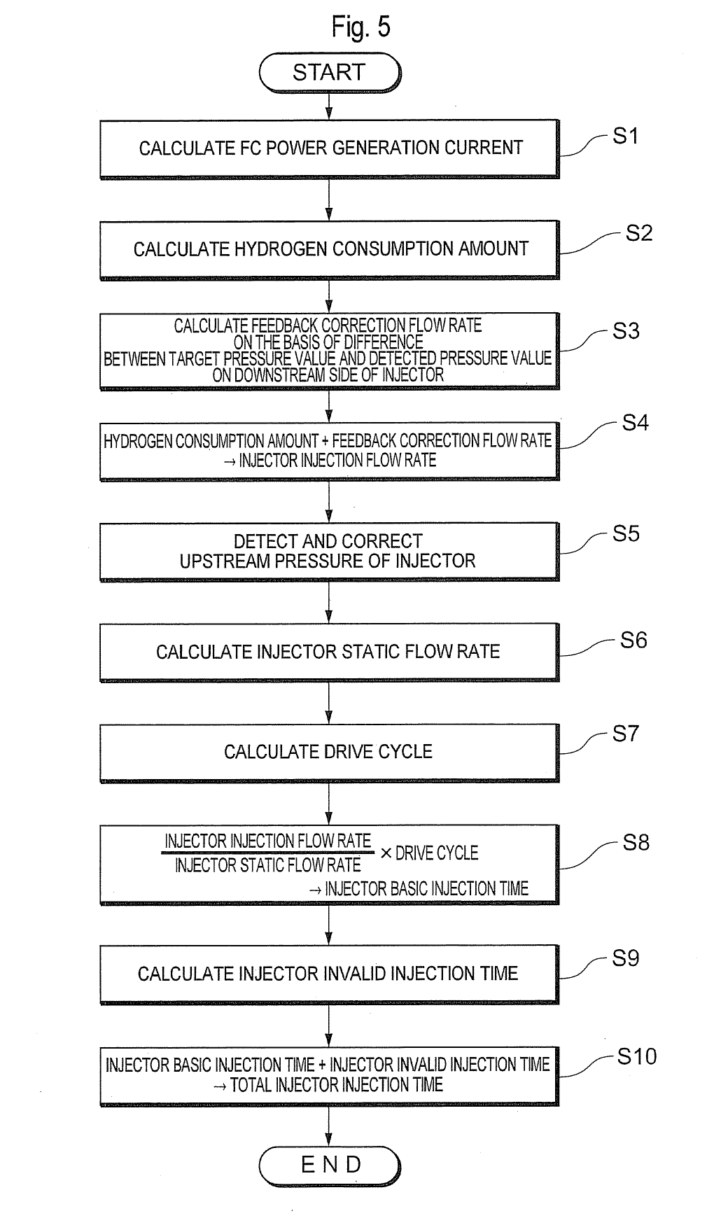

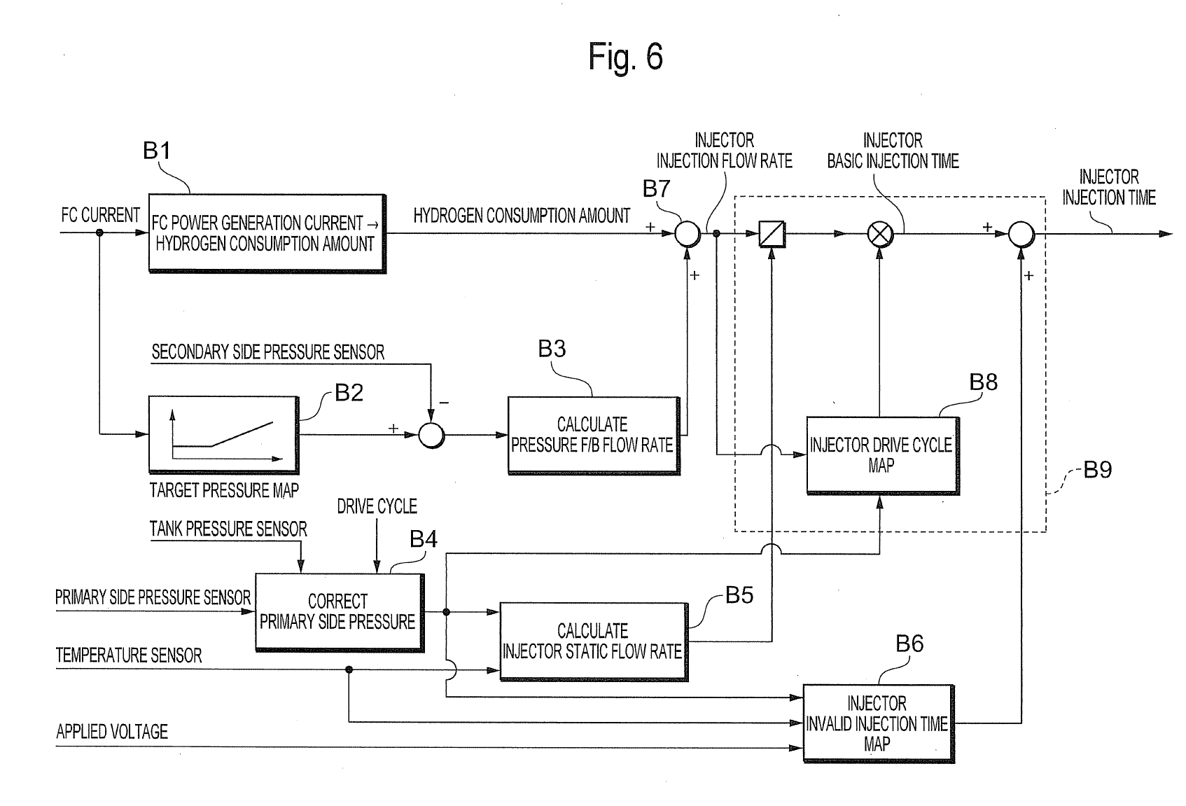

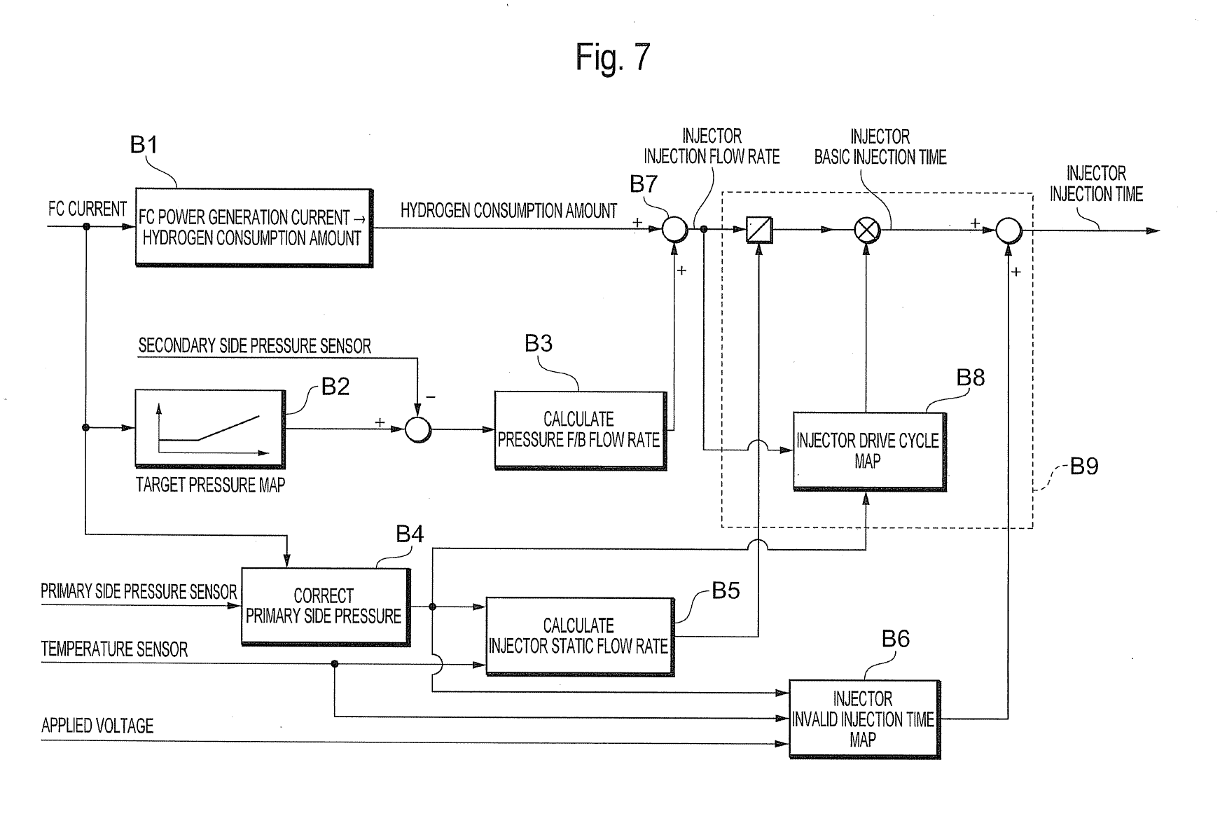

### EXPLANATION OF REFERENCE NUMERALS

1 . . . fuel cell system; 4 . . . controller (control means, pressure correcting means); 10 . . . fuel cell; 30 . . . hydrogen tank (fuel supply source); 31 . . . hydrogen supply flow path (fuel supply flow path); 35 . . . injector (on-off valve); 41 . . . primary side pressure sensor

1. A fuel cell system comprising: a fuel cell; a fuel supply flow path for supplying a fuel gas supplied from a fuel supply source to the fuel cell; an on-off valve which regulates the state of a gas on an upstream side of the fuel supply flow path and supplies the gas to a downstream side; a pressure sensor which detects a pressure value of the fuel gas on the upstream side of the on-off valve of the fuel supply flow path; a control portion which controls the on-off valve on the basis of the pressure value detected by the pressure sensor; and
a pressure correcting device which corrects the pressure value detected by the pressure sensor on the basis of at least one of the power generation amount in the fuel cell, a fuel consumption amount in the fuel cell, the drive cycle of the on-off valve, and open valve command time of the on-off valve.

2. The fuel cell system according to claim 1, wherein the pressure correcting device has a correction map for calculating a corrective pressure reduction on the basis of at least one of the power generation amount in the fuel cell, the fuel consumption amount in the fuel cell, the drive cycle of the on-off valve, and the open valve command time of the on-off valve, and corrects the detected pressure value on the basis of a pressure value detected by the pressure sensor and a corrective pressure reduction calculated by using the correction map.

3. The fuel cell system according to claim 1, comprising an upstream pressure detecting device which detects the pressure value of the fuel gas on the upstream side from the pressure sensor,
wherein the pressure correcting device corrects the pressure value detected by the pressure sensor on the basis of a pressure value detected by the upstream pressure detecting device.

4. The fuel cell system according to claim 3, wherein
the fuel supply source is a hydrogen tank storing a hydrogen gas as a fuel gas, and
the upstream pressure detecting device is a tank pressure sensor which detects the pressure of the hydrogen gas in the hydrogen tank.

5. The fuel cell system according to claim 1,
wherein the on-off valve is an injector.
